(19) United States
(12) Patent Application Publication
(10) Pub. No.: US 2026/0268070 A1
(43) Pub. Date: Sep. 10, 2026

(54) CHART FORMATTING ENGINE IN AN ARTIFICIAL INTELLIGENCE SYSTEM

(71) Applicant: Microsoft Technology Licensing, LLC, Redmond, WA (US)

(72) Inventors: Arjun RADHAKRISHNA, Redmond, WA (US); Vipul GARG, Mountain View, CA (US); Niranjana Tushar DESHPANDE, Redmond, WA (US); Kadambari SINHA, Seattle, WA (US); Johnnie THOMAS, Seattle, WA (US); Sumit GULWANI, Sammamish, WA (US)

(21) Appl. No.: 19/070,311

(22) Filed: Mar. 4, 2025

(51) Int. Cl. G06F 40/18; G06F 40/103

(52) U.S. Cl. CPC G06F 40/18; G06F 40/103

(57) ABSTRACT

Methods, systems, and computer storage media for providing chart formatting management using a chart formatting engine in an artificial intelligence (AI) system are described. The chart formatting engine is integrated into a spreadsheet engine and leverages AI to automate and enhance the creation, customization, and refinement of chart visualizations. The chart formatting engine bridges the gap between static reference images and dynamic, editable charts by applying AI-driven insights and automation to streamline chart styling. The chart formatting engine uses advanced AI to convert formatting elements of a reference chart into edit commands that are used to generate an editable spreadsheet chart that replicates the reference chart's visual style. A multi-modal vision model analyzes the reference-chart, identifies formatting elements and then generates edit commands associated with adjusting the formatting elements. These edit commands are applied programmatically to an original chart to generate a subsequent chart streamlining customization and reducing manual effort.

### BACKGROUND

Users rely on Artificial Intelligence (AI) systems to efficiently retrieve and synthesize relevant information to generate insightful responses to their queries for informed decision making. An AI system is a platform designed to perform tasks that typically require human intelligence, such as understanding language, recognizing patterns, and making decisions, often through learning from data. In particular, an AI system can be used to enhance productivity software, particularly spreadsheets, by automating tasks and providing deeper insights. In spreadsheets, AI-powered tools can automatically analyze data, identify trends, and suggest key insights. The AI system can also enable the automation of repetitive tasks such as data entry, formatting, and report generation.

### SUMMARY

Various aspects of the technology described herein are generally directed to systems, methods, and computer storage media for, among other things, providing chart formatting management using a chart formatting engine in an artificial intelligence (AI) system. The chart formatting engine is integrated into a spreadsheet engine and leverages AI to automate and enhance the creation, customization, and refinement of chart visualizations. The chart formatting engine bridges the gap between static reference images and dynamic, editable charts by applying AI-driven insights and automation to streamline chart styling. The chart formatting engine uses advanced AI to convert formatting elements of a chart image (i.e., a reference-chart) into edit commands that are used to generate a fully editable spreadsheet chart that replicates the chart image's visual style. A multi-modal vision model analyzes the reference-chart, identifies formatting elements such as colors, fonts, spacing, titles, legends, and data labels, and then generates edit commands associated with adjusting the formatting elements. These edit commands are applied programmatically to an original chart to generate a subsequent chart (e.g., a reference-based chart), streamlining customization and reducing manual effort.

In operation, in a first embodiment, a reference-chart is accessed. The reference-chart is analyzed using a multi-modal visual model. Analyzing the reference-chart identifies one or more formatting elements. Based on the one or more formatting elements, one or more edit commands are generated. Based on the one or more edit commands, a reference-based chart is generated using the reference-chart and an original chart. The reference-based chart is formatted as an editable chart based on the one or more formatting elements of the reference-chart. The reference-based chart is caused to be displayed.

In a second embodiment, a reference-chart from a client, associated with an original chart in a spreadsheet application is communicated. Based on communicating the reference-chart, a reference-based chart associated with the reference-chart is received. The reference-based chart is generated using the reference-chart and the original chart. The reference-based chart is formatted as an editable chart based on one or more formatting elements of the reference-chart. The reference-based chart is caused to be displayed.

In a third embodiment, a reference-chart is accessed. The reference-chart is analyzed using a multi-modal visual model. Analyzing the reference-chart identifies one or more formatting elements. Based on the one or more formatting elements, one or more edit commands are generated. Based on the one or more edit commands, a reusable chart template is generated. The reusable chart template is stored.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A-1E are chart formatting management schematics associated with a chart formatting management workflow of a chart formatting engine, in accordance with aspects of the technology described herein;

FIG. 2A is a block diagram of an exemplary AI system including a chart formatting engine, in accordance with aspects of the technology described herein;

FIG. 2B is a flow diagram associated with an exemplary AI system including a chart formatting engine, in accordance with aspects of the technology described herein;

FIG. 3 provides a first exemplary method of providing chart formatting management using a chart formatting engine, in accordance with aspects of the technology described herein;

FIG. 4 provides a second exemplary method of providing chart formatting management using a chart formatting engine, in accordance with aspects of the technology described herein;

FIG. 5 provides a third exemplary method of providing chart formatting management using a chart formatting engine, in accordance with aspects of the technology described herein;

FIG. 6 provides a block diagram of an exemplary computing system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

An artificial intelligence (AI) system is a platform designed to perform tasks that typically require human intelligence, such as understanding language, recognizing patterns, and making decisions, often through learning from data. In particular, an AI system can be integrated into productivity software, particularly spreadsheets (e.g., MICROSOFT EXCEL), to enhance functionality through advanced automation and data analysis capabilities. AI-powered algorithms can autonomously process and analyze large volumes of data, employing techniques such as regression analysis, clustering, and pattern recognition to identify underlying trends and correlations. These insights are then presented as actionable recommendations or visualizations, allowing users to quickly make informed decisions.

The AI system also facilitates the automation of repetitive and time-consuming tasks, such as data entry, data validation, formatting, and report generation. For example, AI in spreadsheet application can automatically fill in missing values based on patterns in the existing data. Additionally, AI can create and apply formulas across large datasets, eliminating the need to manually enter calculations. By leveraging machine learning models, the AI system can intelligently detect data patterns and automatically apply the appropriate formatting or data transformations. Through these capabilities, AI transforms traditional spreadsheets into powerful tools for advanced data analysis, process optimization, and predictive modeling.

Conventionally, AI systems are not configured with a comprehensive computing logic and infrastructure to efficiently and effectively replicate chart styles in spreadsheet applications. Replicating the visual styling of a chart in a spreadsheet can be labor-intensive and error-prone process. Users often face several challenges in this task. First, there is a lack of interoperability, as reference charts are typically available as static images and cannot be directly imported into spreadsheet tools to extract styling elements. Existing solutions, such as “Save as Chart Template,” are limited to editable pre-existing charts, preventing the use of image-based references. Additionally, manual effort in styling is required, as adjusting chart formatting involves numerous steps to modify fine-grained elements like fonts, colors, legends, and data labels. Replicating the desired look and feel through manual editing is time-consuming and demands significant expertise.

Furthermore, there is limited automation for styling, as current tools focus primarily on data visualization creation or data transformation, with little to no support for automatically replicating styling. For example, a user may want to replicate a complex bar chart found on a website for a report in Excel. The chart features custom fonts, specific color schemes, and unique data label placements. However, the original chart is a static image, so the user cannot directly import the design into Excel. The user must manually adjust each element—colors, font styles, and label positions—by trial and error, which can be time-consuming and may still not perfectly match the original. This process lacks automation and is dependent on your ability to replicate the look accurately by eye. Currently, there exists no integrated method available to evaluate and iteratively refine a chart's styling against a reference image. As such, a more comprehensive AI system—with an alternative basis for performing chart formatting—can improve computing operations and interfaces for artificial intelligence systems.

### Description of Technical Solution

At a high level, chart formatting by examples—using a chart formatting engine in an artificial intelligence system—automates and enhances the creation, customization, and refinement of chart visualizations. The chart formatting engine bridges the gap between static reference images and dynamic, editable charts by applying AI-driven insights and automation to streamline chart styling.

To address the challenge of replicating chart styles, the chart formatting engine leverages advanced AI to transform an image of a chart (i.e., a reference-chart image) into a fully editable spreadsheet chart that closely mimics the visual and stylistic elements of the original. At its core, the chart formatting engine approach utilizes a multi-modal vision model to process an input chart image (e.g., reference-chart) and identify formatting elements or options. The formatting elements are associated with edit commands of a spreadsheet application (e.g., spreadsheet engine). These formatting elements include, but are not limited to, colors, fonts, spacing, chart titles, legends, data labels, and other detailed visual elements. For example, the multi-modal vision model identifies formatting elements that translate to edit commands such as: “Show chart legend,” “Set data label font to Helvetica” and “Show error bars to the first data series.” These edit commands are then programmatically applied to a selected chart (e.g., an original chart), resulting in a formatted chart (e.g., a reference-based chart) that replicates the reference chart's style. This significantly reduces the manual effort required to customize chart aesthetics, streamlining the process.

A feature of the chart formatting engine is a self-reflection mechanism. Once the initial edit commands are applied, the reference-based chart is re-evaluated by the model to identify remaining discrepancies with the reference image. This iterative process generates additional commands to refine the reference-based chart further until the desired level of fidelity is achieved.

To provide flexibility, the user is presented with the identified edit commands in interface controls. Users can selectively apply or reject (enable or disable) individual changes, interface controls corresponding to edit commands, allowing for nuanced control over the final chart design. For instance, a user may choose to adopt all suggested changes except enabling the chart legend, ensuring the output aligns with specific preferences or standards.

Additional supported functionality can include reusable chart templates and visual critique. In particular, the edit commands can be abstracted into reusable chart templates, enabling users to apply consistent styling across multiple charts. These reusable chart templates can even be extended to create a unified company theme, standardizing the look and feel of visualizations across an organization.

Furthermore, the multi-modal vision model can also provide contextual visual critiques (e.g., optimization decision analysis) to the style adaptation process. For example: “The reference image uses error bars for all data series, but the current data's error bars are too small to convey meaningful information. This change has been omitted.” The optimization decision analysis can be displayed in combination with the reference-based chart. Such critiques ensure that stylistic changes are both accurate and meaningful, preventing unnecessary or counterproductive modifications.

In this way, the chart formatting engine offers numerous benefits, streamlining the chart customization process with advanced automation that eliminates the need for time-consuming manual adjustments. By working directly with chart images, it overcomes the limitations of existing tools that require editable charts, providing unparalleled flexibility. Its precision-driven approach ensures high fidelity to the reference style through iterative refinement and detailed command generation. Additionally, the system empowers users by offering transparency and control, allowing them to tailor the final output to their specific needs and preferences.

### Example Systems And Resources

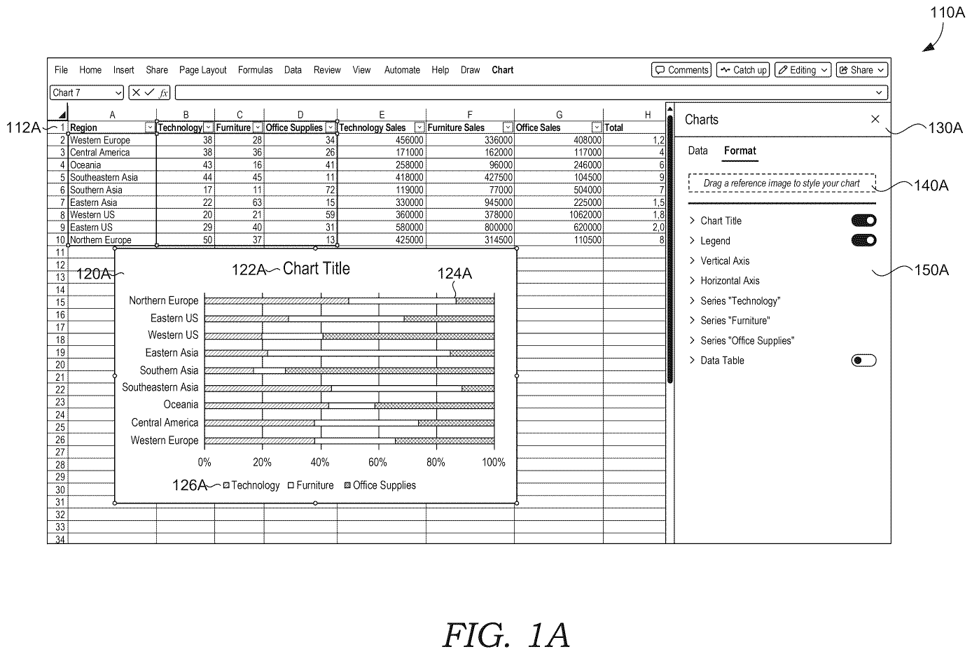

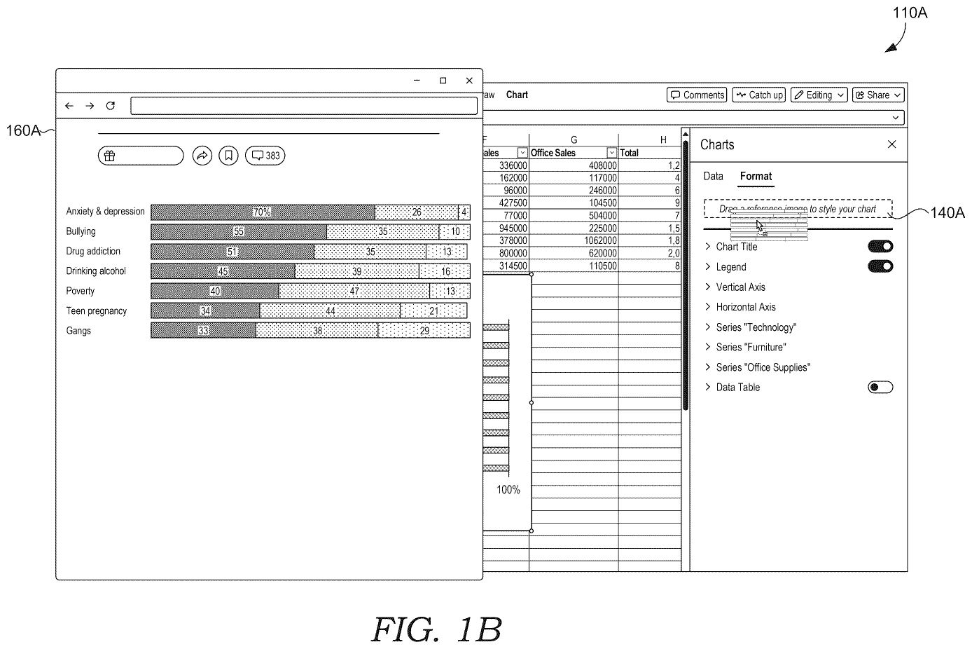

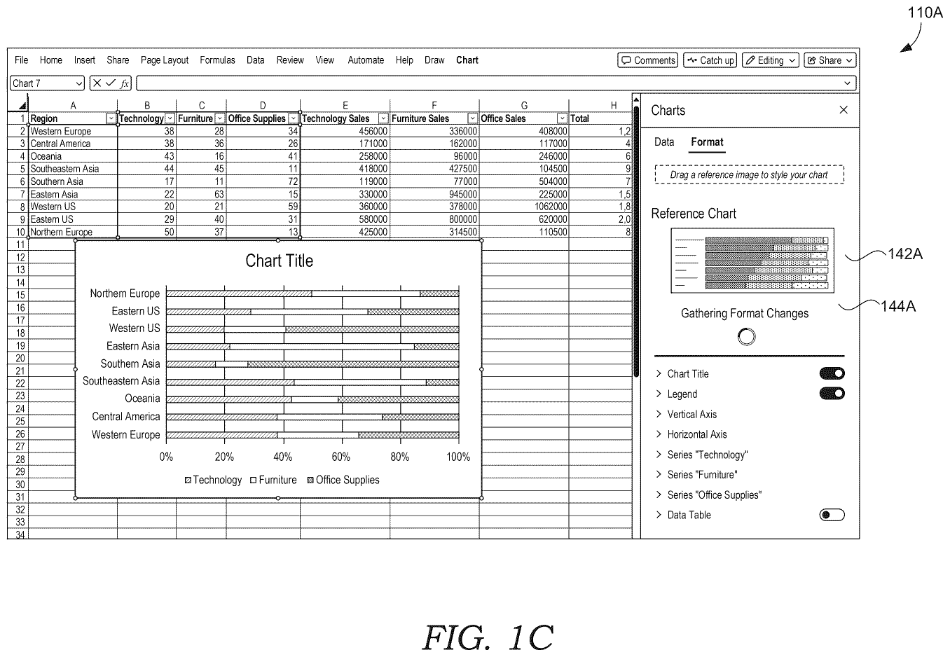

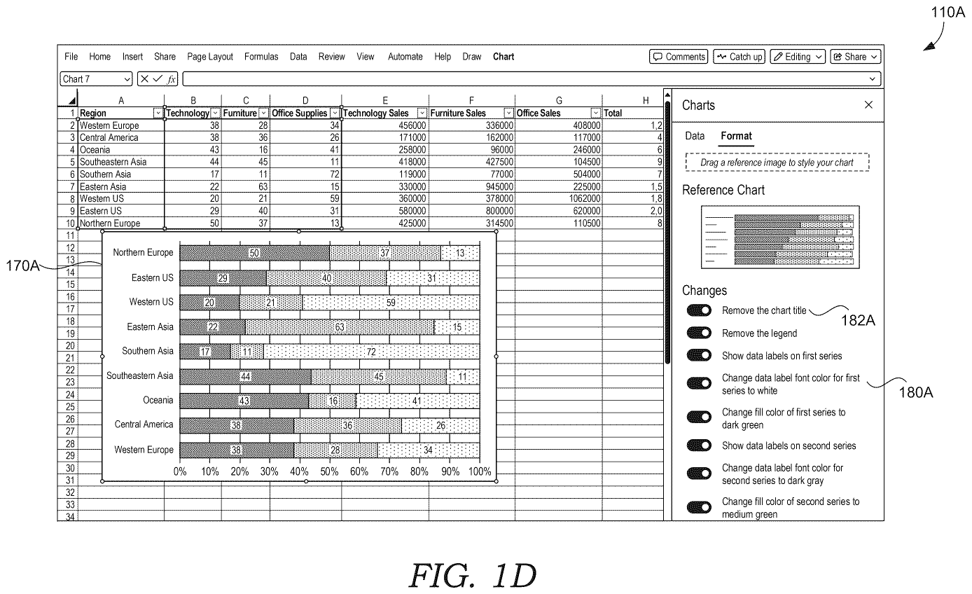

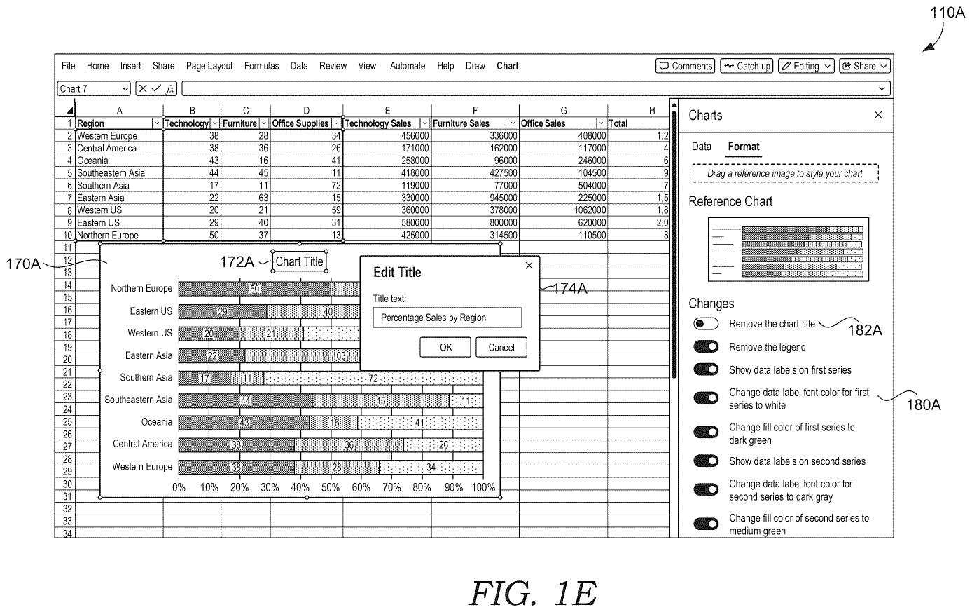

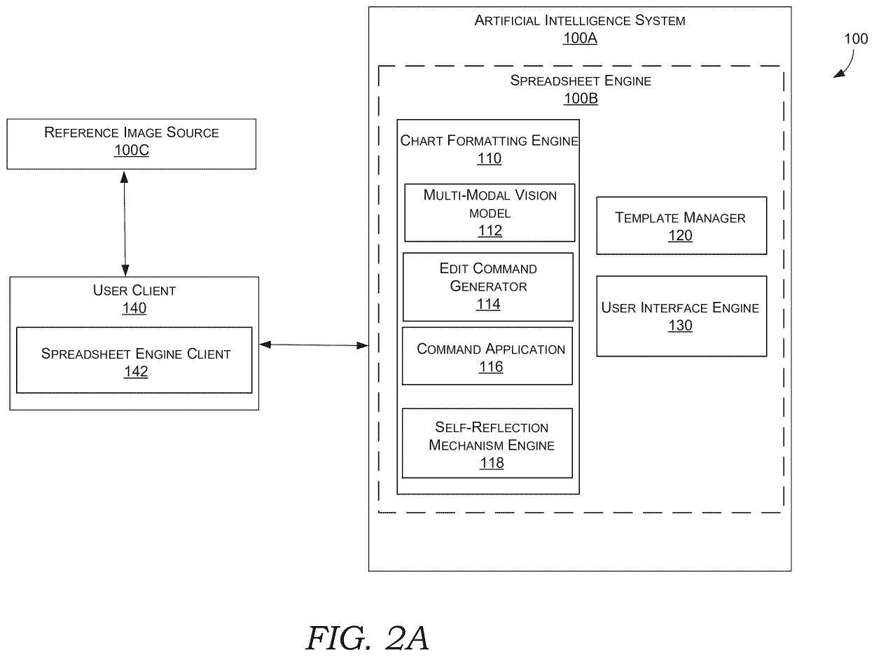

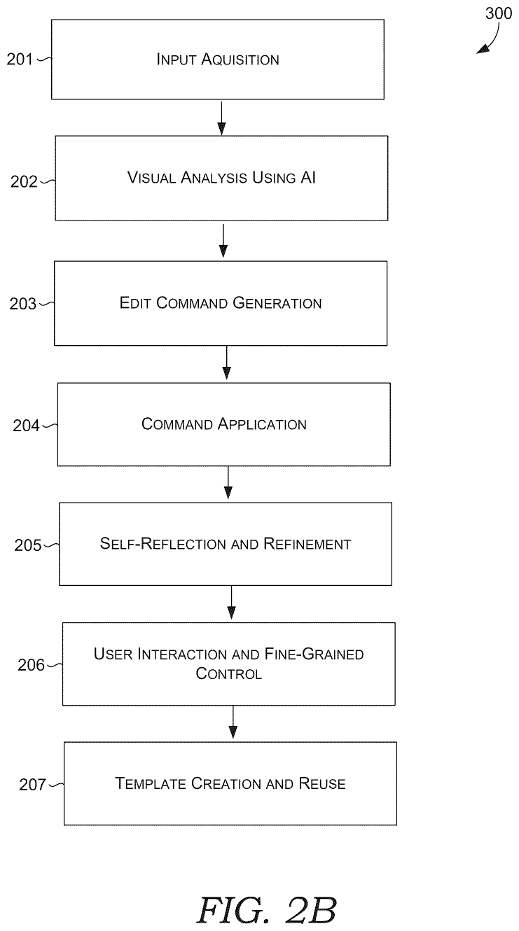

Aspects of the technical solution can be described by way of examples and with reference to FIGS. 1A, 1B, 2A and 2B. FIG. 1A illustrates spreadsheet engine interface 110A associated with chart formatting management. The spreadsheet engine interface 110A supports data organization, analysis, and visualization. The spreadsheet engine interface 110A includes spreadsheet 112A, a chart 120A, chart title placeholder 122A, stacked bar chart 124A, legend 126A, customization panel 130A, reference-chart upload interface portion 140A, and chart element controls portion 150A with a plurality of chart element interface controls.

Chart 120A is a visual representation of data from the spreadsheet 112A. Chart 120A can be an embedded chart placed directly within the spreadsheet 112A workspace, linked to the underlying data. Chart 120A includes chart title placeholder 122A and stacked bar chart 124A where each bar represents the total value of a dataset. The legend 126A is a chart element that explains the meaning of colors, patterns, or symbols used in the chart to represent data series (e.g., Technology, Furniture, or Office Supplies). Customization panel 130A provides an interactive menu that allows user to modify elements of a chart, such as toggling the chart title, legend, or axis.

FIG. 1B illustrates reference-chart 160A (or a reference-chart image) that is uploaded into reference-chart upload interface portion 140A. FIG. 1C illustrates a thumbnail icon 142A—a representation of the reference-chart 160A and activity indicator 144A associated with reference-chart upload interface portion 140A indicating (e.g., “Gathering Format Changes”) that reference-chart 160A is being analyzed.

FIG. 1D illustrates reference-based chart 170A that is generated based on the reference-chart 160A. Chart element controls portion 150A in a reference-chart-based edit command interface portion 180A including a plurality of edit commands identified based on reference-chart 160A. The plurality of edit commands can specifically be formatting changes made to the chart 120A to convert the chart 120A to the reference-based chart 170A. For example, the remove the chart title toggle 182 is a change made to the chart 120A because the reference-chart 160A does not have a title.

FIG. 1E illustrates remove the chart title toggle 182 that is toggled off. Toggling it undoes the removal of the chart title from chart 120A and restores a reference-chart-based chart title placeholder 172A. The reference-chart-based chart title placeholder 172A has other formatting elements based on the reference-chart 160A that are still toggled on. Double-clicking on the reference-chart-based chart title placeholder 172A opens a edit title pop-up window 174 that can be used to edit the title of the chart.

The technical solution can be described by way of example to a project involving the analysis of sales data for different product categories: Technology, Furniture, and Office Supplies. The data is organized in a spreadsheet, and a visual representation of this data is desired to better understand the trends and patterns.

The sales data is entered into the spreadsheet. Once the data is in place, the spreadsheet engine interface is used to create a chart. A stacked bar chart is chosen to help see the total sales for each category. The chart includes a title placeholder and a legend that explains the colors representing each category.

Next, the chart (i.e., original chart) is customized to make it more informative. A reference chart from a previous report is used as a template. An image of the reference chart is uploaded into the reference-chart upload interface portion. A thumbnail icon of the reference chart appears, and an activity indicator shows that the reference chart is being analyzed, displaying a message like “Gathering Format Changes.”

Based on the analysis of the reference chart, the chart formatting engine identifies several formatting changes that can be applied to the current chart. For example, the reference chart does not have a title, so the chart formatting engine suggests removing the chart title from the current chart. Other formatting changes, such as color schemes and axis labels, are also applied to ensure consistency with the reference chart.

The customization panel, an interactive menu, is provided to modify various elements of the chart identified as edit commands (e.g., changes). For example, the chart title is toggled on and off to see how it looks with and without the title. The legend and axis labels can be adjusted to ensure they are clear and easy to understand. The chart title is toggled back such that the chart title placeholder is restored, but with formatting elements based on the reference chart. This ensures that the chart title is consistent with the overall design of the reference chart.

As such, a customized and visually appealing chart that accurately represents the sales data is successfully created. The chart formatting engine makes it easy to organize, analyze, and visualize the data, while also allowing elements from a reference chart to be incorporated to maintain consistency in reports.

With reference to FIG. 2A, FIG. 2A, illustrates a cloud computing system 100, artificial intelligence (AI) system 100A, spreadsheet engine 100B, chart formatting engine 110, multi-modal vision model 112, edit command generator 114, command application engine 116, self-reflection mechanism engine 118, reusable chart template manager 120, and user interface engine 130.

Cloud computing system 100 is an operating environment supporting processing reference images, generating edit commands, applying changes, and iteratively refining charts for optimal user satisfaction. Chart formatting engine 110 leverages cloud computing system 100 that integrates multiple components to provide AI-driven solution for chart formatting within a spreadsheet environment.

AI system 100A serves as the computational backbone for the chart formatting engine. AI system 100A is responsible for handling the complex operations required for visual analysis and iterative refinement. AI system 100A interacts with the spreadsheet engine 100B, ensuring that the edits generated are compatible with native chart formatting capabilities of the spreadsheet engine 100B. The spreadsheet engine 100B operates as the platform where a spreadsheet application is provided and data is organized, analyzed, and visualized, with the chart formatting engine 110 acting as an enhancement layer to improve visual styling and presentation.

User client 140 represents a client device through which a user interacts with the spreadsheet engine 100B. User client 140 could be associated with a web browser, desktop application, or mobile app, depending on the deployment. The spreadsheet engine client 142 can be a specific interface associated with the spreadsheet engine 100B where users access and utilize the chart formatting engine 110. User client 140 integrates with the spreadsheet engine 100B in different types of deployment models of the spreadsheet engine 100B.

Reference image source 100C provides the input chart or reference chart. Users upload reference charts (e.g., static chart images) via user client 140 and spreadsheet engine client 142, which supports a variety of image formats. This source feeds the uploaded images to the chart formatting engine 110 which facilitates the orchestration of transforming these static references into editable charts.

Chart formatting engine 110 includes multi-modal vision model 112 that is an advanced AI model that analyzes the uploaded chart image to extract key stylistic and structural formatting elements. Multi-modal vision model 112 identifies formatting elements such as axes, gridlines, data series, legends, titles, fonts, colors, and other visual characteristics. These formatting elements are mapped to corresponding editable properties within the spreadsheet engine, serving as the foundation for the subsequent formatting operations.

Edit command generator 114 converts the extracted formatting elements into actionable edit commands tailored to the spreadsheet engine 100B. Edit commands are detailed instructions, such as “Set axis font to Arial,” “Change bar color to blue,” or “Enable data labels.” Edit command generator 114 ensures that these edit commands align with chart customization capabilities of spreadsheet engine 100B, bridging the gap between the static reference image and dynamic chart editing.

Once the edit commands are generated, they are executed by the command application engine 116. Command application engine 116 programmatically applies the formatting commands to a selected chart within the spreadsheet engine 100B. The initial application transforms the chart's appearance to closely resemble the reference image, laying the groundwork for further refinements. It is contemplated that edit commands can be used to generate a new chart based on the reference chart without initially identifying a selected chart.

Command application engine 116 also support optimization decision analysis for evaluating different options or approaches to improve the effectiveness and clarity of data presentation, while considering the trade-offs and potential benefits of each option. For example, the command application engine 116 might find that the error bars from a reference chart are too small to be useful and conclude that further adjustments would not enhance the representation of uncertainty or variability in the reference-based chart. It is a structured evaluation process where the command application engine 116 determines the best course of action for improving the data visualization (such as adjusting error bars) of the original chart based on its assessment of effectiveness, clarity, and relevance.

The self-reflection mechanism engine 118 introduces an iterative feedback loop. After the initial application of edit commands, self-reflection mechanism engine 118 evaluates the updated chart (i.e., reference-based chart) against the reference image to detect any remaining discrepancies. Based on this analysis, additional edit commands are generated to address issues such as mismatched colors, misaligned elements, or missing features. This iterative process continues until the chart achieves a high level of fidelity to the reference.

User interface engine 130 facilitates interaction between users and the spreadsheet engine 100B. User interface engine 130 powers the graphical interface, managing user inputs and displaying outputs such as previewed charts and edit suggestions. User interface engine 130 ensures that user interactions are smooth and intuitive. User interface engine 130 via the spreadsheet engine client 142 provides users with an interactive platform to review, accept, or modify the generated edits. Commands are presented as interface controls in natural language, making them easy to understand and evaluate. Users can selectively apply or reject specific changes, ensuring the final chart meets their preferences and standards. Real-time previews of the chart allow users to visualize the impact of their choices, enhancing the decision-making process.

Reusable chart template manager 122 enables users to save applied edits as reusable chart templates. These templates can be stored in the cloud for future use, allowing consistent application of styles across projects and organizations. The ability to define and reuse templates simplifies workflows and promotes uniformity in chart design.

Together, these components form a robust and scalable system for automated chart formatting. The integration of cloud computing, advanced AI, and user-centric interfaces ensures efficiency, precision, and flexibility, delivering a cutting-edge solution for professional chart creation and styling.

By way of illustration, the technical implementation begins with the user accessing a reference-chart, which is typically a static image visually representing the desired chart style. The reference-chart serves as the input for the chart formatting engine, allowing users to communicate their desired aesthetic. This is done through a user client, which provides a user-friendly interface, or a spreadsheet engine client, which integrates with a spreadsheet application. Uploading the reference-chart initializes the process of transforming its static visual elements into a formatted, editable chart that combines the reference style with the data structure of an original chart within the spreadsheet.

Upon receiving the reference-chart, the chart formatting engine uses a multi-modal visual model to analyze it. This AI-powered model interprets the visual components of the reference-chart and identifies formatting elements critical to its style. These formatting elements may include axis styling (e.g., labels, fonts, and scaling), legend placement, bar or line colors, gridline spacing, titles, data label configurations, and the overall layout. Formatting elements are the visual and structural properties of the chart that define its aesthetic and can be used for replicating its visual style. By extracting these formatting elements, the chart formatting engine establishes a comprehensive map of the reference-chart's design.

For an identified formatting element, the chart formatting engine generates edit command. The chart formatting engine can employ edit command mapping to generate edit commands tailored to the spreadsheet application. Edit commands are programmatically defined instructions that control specific aspects of chart formatting. For example, if the reference-chart uses bold, left-aligned axis titles, the chart formatting engine generates commands such as “Set axis title font to bold” and “Align axis title to left.” This mapping ensures that the extracted formatting elements are accurately translated into actionable commands compatible with the spreadsheet's chart customization features.

Chart formatting engine executes the generated edit commands on the original chart within the spreadsheet application, producing a reference-based chart. Ther reference-based chart retains the structural data of the original chart while adopting the formatting elements extracted from the reference-chart. The reference-based chart is fully editable, enabling users to make further adjustments if needed. This transformation bridges the gap between the static reference image and a dynamic, editable chart.

Chart formatting engine supports optimization decision analysis that refers to determining whether certain formatting elements or stylistic adaptations are meaningful, effective, or applicable to the reference-based chart. For example, if the reference-chart includes error bars for all data series, but the error bars derived from the current dataset are too small to provide significant insight, the chart formatting engine might decide to omit this element. The optimization decision ensures that the chart retains visual clarity and avoids the application of unnecessary or counterproductive changes.

Operationally, optimization decision analysis involves: analyzing whether the formatting elements from the reference-chart align with the characteristics of the original chart data; determining whether to apply, modify, or omit certain formatting elements based on their utility and clarity in the context of the current chart; and generating explanations for decisions, such as “The reference image uses gridlines, but applying them to the current chart may obscure the data points.”

When the chart formatting engine generates the reference-based chart, it causes the display of the optimization decision analysis alongside the chart. This analysis includes feedback on formatting elements from the reference-chart that were not applied, along with the rationale for their exclusion or modification. For example, it may state, “The reference image uses multiple gridlines, but these have been omitted in the reference-based chart to avoid visual clutter.”

After the reference-based chart is generated, the chart formatting engine displays it along with the associated edit commands. These edit commands are presented through interface controls, which allow users to selectively enable or disable specific changes. For instance, if an edit command adjusts gridline styling and the user deems it unnecessary, they can disable that command, resulting in the removal of the corresponding formatting element. This functionality provides users with fine-grained control, ensuring the final chart aligns with their specific preferences and requirements.

To refine the reference-based chart further, the chart formatting engine employs a self-reflection mechanism. This process compares the updated chart with the original reference-chart to identify any remaining discrepancies, such as mismatched colors or misaligned elements. If discrepancies are found, the chart formatting engine generates additional edit commands to address them. This iterative refinement continues until the chart achieves a high level of fidelity to the reference-chart, ensuring the output accurately replicates the desired visual style.

Beyond creating the reference-based chart, the chart formatting engine offers the capability to generate a reusable chart template. The reusable chart template encapsulates the styling elements of the reference-chart in a form derived from the executed edit commands. For example, it might save a specific color palette, font style, and legend positioning. These reusable chart templates can be stored in the template manager and applied to other charts, enabling users to maintain consistent styling across multiple visualizations or projects. By doing so, the chart formatting engine enhances efficiency and promotes standardization in chart design.

Once the reference-based chart is finalized, the chart formatting engine communicates it back to the user's spreadsheet application for display. The reference-based chart is accessible for further interaction, allowing users to modify specific elements or save the generated template for future use. This integration ensures that users can seamlessly leverage the system's capabilities within their existing spreadsheet workflows, enhancing both usability and productivity.

With reference to FIG. 2B, FIG. 2B a flow chart 200B associated with providing a chart formatting management using a chart formatting engine in accordance with embodiments described herein. The technical solution of the chart formatting engine can be explained by way of steps and an example chart formatting scenario.

At step 201: Input Acquisition—the process begins by allowing the user to upload a reference chart image. This can be done through an intuitive interface within the spreadsheet engine, which supports either direct uploads or selection from a library of existing images. The spreadsheet may ensure compatibility with standard image formats and provides clear prompts to guide the user through the input process.

At step 202: Visual Analysis Using AI—once the reference chart image is uploaded, a multi-modal vision model analyzes the reference chart image to extract its visual and stylistic attributes. The multi-modal vision model identifies structural components such as axes, gridlines, data series, legends, and titles, as well as detailed styling elements like colors, fonts, line thickness, and spacing. The multi-modal vision model also detects the presence or absence of optional elements, such as data labels or error bars. This analysis produces a structured representation of the chart, mapping its visual characteristics to editable properties within the spreadsheet.

At step 203: Edit Command Generation—using the extracted attributes, the chart formatting engine generates edit commands, each corresponding to a specific chart customization action. These edit commands are tailored to the spreadsheet engine's native chart formatting capabilities. For instance, the chart formatting engine might produce commands like “Set chart title font to Arial,” “Add a legend below the chart,” or “Change the color of the first data series to blue.” This ensures that the suggested edits are actionable and directly applicable within the spreadsheet environment.

At step 204: Command Application—the generated edit commands are applied programmatically to a selected chart within the spreadsheet. The chart formatting engine uses these commands to render an updated version of the chart, styled to mimic the reference image. This initial application forms the foundation for further refinement, ensuring that key elements and formatting closely resemble the original design.

At step 205: Self-reflection mechanism—After the initial commands are applied, the engine compares the updated chart against the reference image using the same AI model. This self-reflection process identifies any remaining discrepancies, such as slight mismatches in color, spacing, or missing elements. The engine generates additional edit commands to address these differences and iteratively refines the chart. This process continues until the chart formatting engine achieves the desired level of fidelity to the reference image.

At step 206: User Interaction and Fine-Grained Control-The engine empowers users by presenting the generated edit commands in natural language, enabling them to review and modify the changes. Users can selectively accept or reject individual commands, providing granular control over the final design. For instance, a user might choose to adopt all changes except enabling the chart legend. Real-time previews of the updated chart allow users to visualize the impact of each modification, ensuring that the final output meets their preferences or organizational standards.

At step 7: Template Creation and Reuse-to enhance usability, the chart formatting engine allows users to save the applied edit commands as reusable chart templates. These templates can be stored locally or in the cloud, making it easy to apply consistent styling across multiple charts or projects. By leveraging this feature, users can create organization-wide themes or ensure uniformity in their visual presentations, saving time and effort in future workflows.

By way of example, a user, Sarah, has a dataset in her spreadsheet that she wants to visualize using a bar chart. She has found an image of a professionally styled bar chart online and wishes to replicate its appearance for her data. Using the chart formatting engine integrated into her spreadsheet software, Sarah begins the process by uploading the chart image through the chart formatting engine's interface. The reference image, showcasing elements such as a bold title, specific axis fonts, custom bar colors, and a neatly placed legend, serves as the visual inspiration for her desired chart.

Once the image is uploaded, the chart formatting engine processes the image using its multi-modal vision model. The model carefully analyzes the uploaded chart, identifying key structural components like the chart's title, axes, bars, gridlines, and legend. It also extracts detailed stylistic attributes, such as the font used for the title, the color palette of the bars, the spacing between gridlines, and the position of the legend. The chart formatting engine maps these attributes to editable properties compatible with Sarah's spreadsheet application.

With the extracted attributes, the edit command generator creates actionable commands, such as “Set chart title font to Arial Black,” “Change bar colors to a gradient of blue and green,” “Position legend at the top right,” and “Enable gridlines with 50% opacity.” These edit commands are tailored to the spreadsheet engine's chart customization features and are queued for application.

The command application engine then programmatically applies these commands to Sarah's existing bar chart in the spreadsheet. The chart formatting engine's optimization decision analysis ensures that the visual adaptations from the reference-chart are both meaningful and appropriate for her data. As the chart formatting engine applies the styling from the reference-chart, it evaluates formatting elements in the context of the original chart's data. For example, while the reference-chart includes error bars for all data series, the optimization decision analysis determines that Sarah's dataset contains error bars too small to convey meaningful insights. To prevent unnecessary visual clutter, the chart formatting engine decides to omit this element.

Similarly, the chart formatting engine critiques other stylistic choices, such as gridline density or color contrasts, to ensure the final chart is both visually appealing and effective in communicating data. These decisions, such as “Error bars have been omitted due to their negligible impact,” are presented to Sarah alongside the reference-based chart. This transparent feedback allows Sarah to review the rationale behind each modification, empowering her to make informed adjustments while ensuring the final chart aligns with her data and aesthetic goals.

The initial rendering of the chart closely mirrors the style of the reference image, but slight differences, such as the exact shade of blue or the spacing of gridlines, remain. To address these discrepancies, the self-reflection mechanism engine compares the updated chart to the reference image. It identifies mismatches in bar color gradients and spacing, generating additional commands to fine-tune the chart. These refinements are applied iteratively, with each pass improving the fidelity of the chart to the original style.

During this process, Sarah interacts with the user interface to review the suggested changes. The chart formatting engine presents each edit in natural language, such as “Adjust bar colors to deeper blue tones” or “Reduce gridline spacing.” Sarah reviews the updates in real time and decides to accept all changes except one, opting not to include the gridlines as she feels they clutter the design.

Satisfied with the final appearance, Sarah saves the applied styling as a reusable template using the reusable chart template manager. This allows her to apply the same design to future charts effortlessly, maintaining a consistent visual identity across her reports.

In the end, Sarah has a professionally styled bar chart that matches the aesthetics of her reference image, all achieved with minimal effort. The chart formatting engine automated the complex task of replicating the chart's style while allowing Sarah to customize the output to her preferences, streamlining her workflow and enhancing the quality of her presentation.

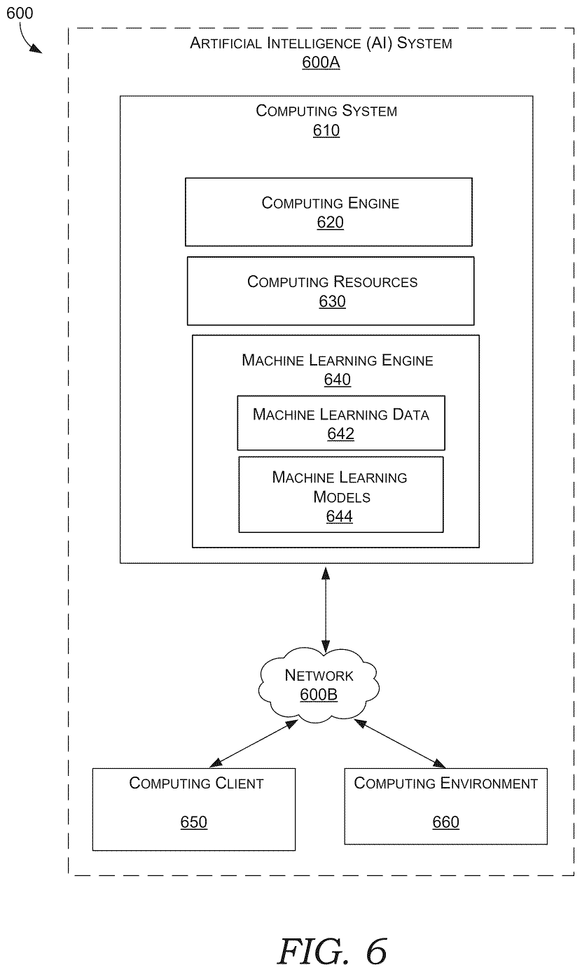

Aspects of the technical solution have been described by way of examples and with reference to FIGS. 1A, 1B, and 2. FIG. 1A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high-level architecture of the cloud computing system 100 in accordance with implementations of the present disclosure, among other engines, managers, generators, selectors, or components not shown (collectively referred to herein as “components”).

### Example Methods

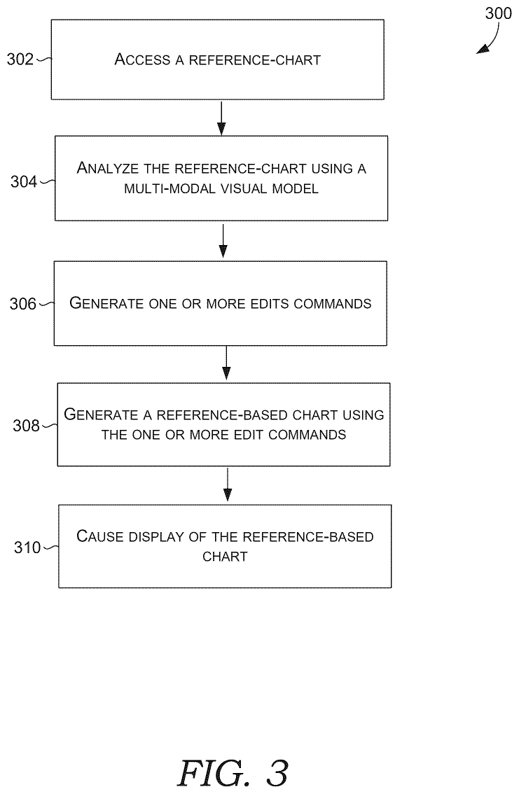

With reference to FIGS. 3, 4, and 5, flow diagrams are provided illustrating methods for providing chart formatting management using a chart formatting engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system).

Turning to FIG. 3, a flow diagram is provided that illustrates a method 300 for providing chart formatting management using a chart formatting engine in an artificial intelligence system. At block 302, access a reference chart. At block 304, analyze the reference-chart using a multi-modal visual model. At block 306, generate one or more edit commands. At block 308, generate a reference-based chart using the one or more edit commands. At block 310, cause display of the reference-based chart.

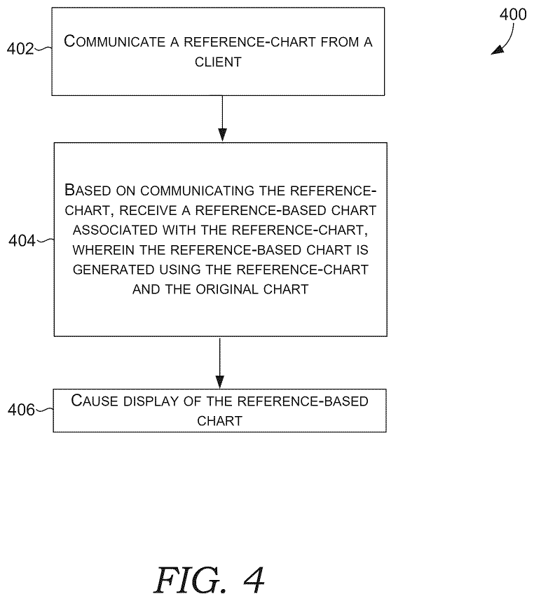

Turning to FIG. 4, a flow diagram is provided that illustrates a method 400 for providing chart formatting management using a chart formatting engine in an artificial intelligence system. At block 402, communicate a reference-chart from a client. At block 404, based on communicating the reference-based chart, receive a reference-based chart associated with the reference-chart. The reference-based chart is generated using the reference-chart and the original chart. At block 406, causing display of the reference-based chart. Causing display of the reference-based chart causes display of one or more edit commands associated with generating the reference-based chart from the reference-chart, wherein the one or more edit commands are associated with interface controls to selectively enable or disable a corresponding edit command.

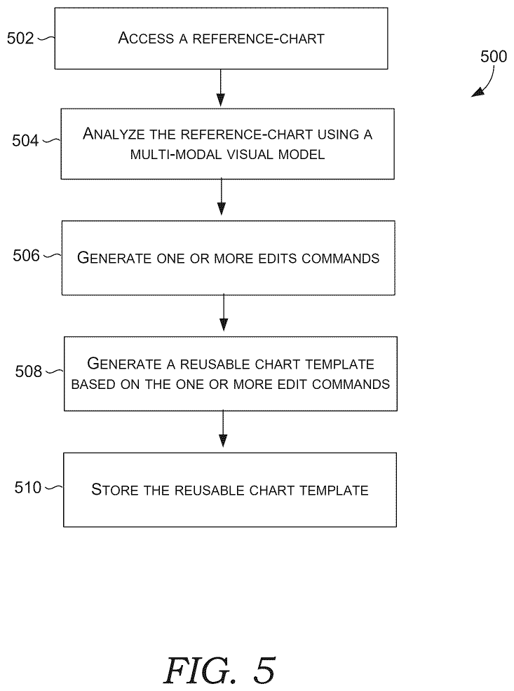

Turning to FIG. 5, a flow diagram is provided that illustrates a method 500 for providing chart formatting management using a chart formatting engine in an artificial intelligence system. At block 502, access a reference-chart. At block 504, analyze the reference-chart using a multi-modal visual model. At block 506, generate one or more edit commands. At block 508, generate a reusable chart template based on the one or more edit commands. At block 510, store the reusable chart template.

### Technical Improvement

Embodiments of the present techniques have been described with reference to several inventive features (e.g., operations, systems, engines, and components) associated with an artificial intelligence system. Inventive features described include operations, interfaces, data structures, and arrangements of computing resources associated with providing the functionality described herein relative with reference to a chart formatting engine 110. Functionality of the embodiments of the present invention have further been described, by way of an implementation and anecdotal examples—to demonstrate that the operations for providing the chart formatting engine 110 as a solution to a specific problem in artificial systems technology to improve computing operations in artificial intelligence systems.

The chart formatting engine represents a significant technical improvement by automating the complex process of replicating and adapting the visual style of static reference-chart images into editable charts within a spreadsheet application. The chart formatting engine eliminates the traditionally labor-intensive task of manually adjusting formatting elements, such as colors, fonts, axis labels, legends, and gridlines, by employing a multi-modal vision model to analyze the reference image. Key operations include identifying critical formatting elements from the reference-chart, mapping these elements to precise edit commands compatible with the spreadsheet engine, and programmatically applying these commands to generate a reference-based chart.

The chart formatting engine further incorporates a self-reflection mechanism, which iteratively refines the chart by comparing it to the reference image, generating additional edit commands to address discrepancies and ensure high fidelity to the original design. A unique optimization decision analysis capability evaluates whether certain stylistic elements are meaningful or effective in the context of the chart's data, preventing the application of unnecessary or counterproductive modifications. Users are empowered with interactive interface controls, enabling them to selectively apply, reject, or modify individual changes with real-time previews. Additionally, the system allows users to save the applied styles as reusable chart templates, facilitating consistent formatting across projects and promoting efficiency in repetitive workflows.

By automating chart customization, the chart formatting engine dramatically reduces the time and effort required to produce visually compelling data presentations. Its advanced capabilities ensure accuracy, flexibility, and transparency, while the integration of iterative refinement and decision analysis guarantees that the final chart not only aligns with the reference but also enhances data clarity and communication. The technical solution streamlines the creation of chart visualizations, making it an indispensable tool for users seeking efficiency and precision in chart design.

### ADDITIONAL SUPPORT FOR DETAILED DESCRIPTION

### Example Artificial Intelligence (AI) System in a Computing Environment

Referring now to FIG. 6, FIG. 6 illustrates a computing environment in which implementations of the present disclosure may be employed. In particular, FIG. 6 shows a high level architecture of an example cloud computing platform 600, artificial intelligence (AI) system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services—including compute, servers, storage, databases, networking, and intelligence. The components of cloud computing platform 600 may communicate with each other over a network 600B which may include, without limitation, one or more local area networks (LANs) and/or wide area networks (WANs).

The AI system 600A provides a specialized infrastructure designed to support the computational demands of artificial intelligence (AI) workloads, including both training and inference tasks. The AI backend network systems 600A consists of interconnected components that facilitate the efficient processing, communication, and management of data within a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing system 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 640 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### Example Distributed Computing System Environment

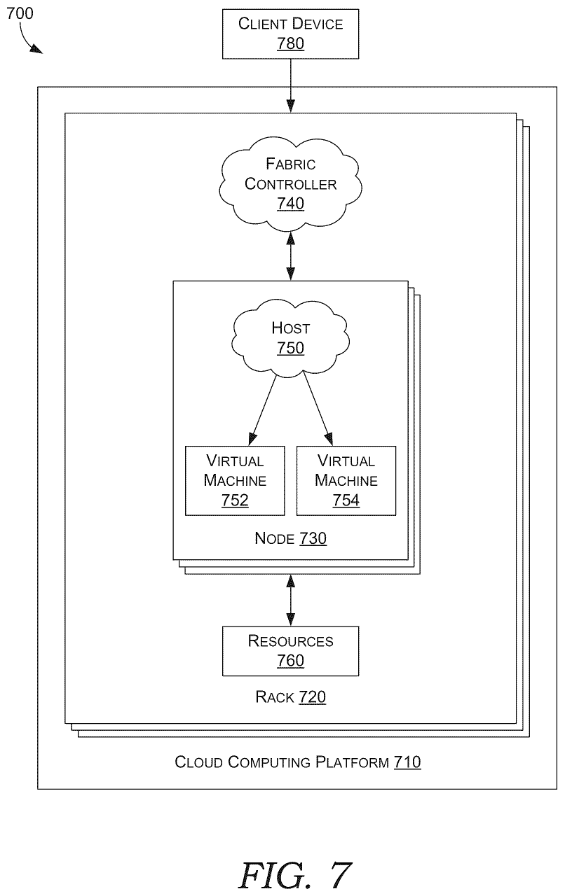

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

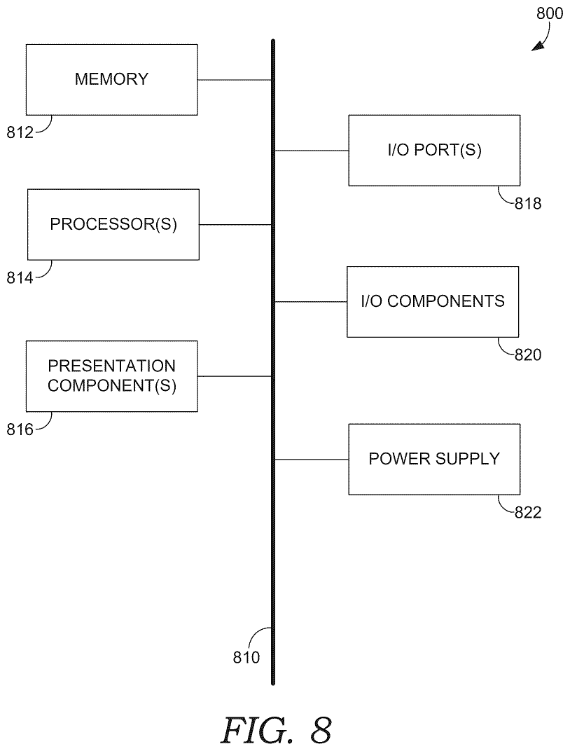

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors;
computer memory storing computer-useable instructions that, when used by the one or more computer processors, cause the one or more computer processors to perform operations, the operations comprising:
accessing a reference-chart;
analyzing the reference-chart using a multi-modal visual model, wherein analyzing the reference-chart identifies one or more formatting elements,
based on the one or more formatting elements, generating one or more edit commands;
based on the one or more edit commands, generating a reference-based chart using the reference-chart and an original chart, wherein the reference-based chart is formatted as an editable chart based on the one or more formatting elements of the reference-chart; and
causing display of the reference-based chart.

2. The system of claim 1, wherein the one or more formatting elements are formatting elements of the reference-chart that enable replicating a visual style associated with an image of the reference-chart.

3. The system of claim 1, wherein generating the one or more edit commands is based on mapping a formatting element to an edit command of a spreadsheet application of the reference-based chart, the edit command is configured to control the formatting element.

4. The system of claim 3, wherein generating the reference-based chart is based on executing the one or more edit commands identified based on the reference-chart.

5. The system of claim 1, wherein causing display of the reference-based chart causes display of one or more edit commands associated with generating the reference-based chart from the reference-chart, wherein the one or more edit commands are associated with interface controls to selectively enable or disable a corresponding edit command.

6. The system of claim 1, the operations further comprising:
using a self-reflection mechanism, iteratively refining the reference-based chart, wherein the self-reflection mechanism compares the reference-based chart to the reference-chart and generates one or more additional edit commands.

7. The system of claim 1, the operations further comprising generating a reusable chart template based on the one or more edit commands.

8. One or more computer-storage media having computer-executable instructions embodied thereon that, when executed by a computing system having a processor and memory, cause the processor to perform operations, the operations comprising:
communicating a reference-chart from a client, associated with an original chart in a spreadsheet application;
based on communicating the reference-chart, receiving a reference-based chart associated with the reference-chart, wherein the reference-based chart is generated using the reference-chart and the original chart, wherein the reference-based chart is formatted as an editable chart based on one or more formatting elements of the reference-chart; and
causing display of the reference-based chart.

9. The media of claim 8, wherein causing display of the reference-based chart comprises causing display of an optimization decision analysis associated with a formatting element of the reference-chart that is not applied to the reference-based chart.

10. The media of claim 8, wherein generating the reference-based chart is based on analyzing the reference-chart using a multi-modal visual model, wherein analyzing the reference-chart identifies the one or more formatting elements.

11. The media of claim 10, wherein analyzing the reference-chart comprises generating one or more edit commands, wherein generating an edit command is based on mapping a formatting element to an edit command of a spreadsheet application of the reference-based chart, the edit command is configured to control the formatting element.

12. The media of claim 11, wherein generating the reference-based chart is based on executing the one or more edit commands identified based on the reference-chart.

13. The media of claim 8, wherein causing display of the reference-based chart causes display of one or more edit commands associated with generating the reference-based chart from the reference-chart, wherein the one or more edit commands are associated with interface controls to selectively enable or disable a corresponding edit command.

14. The media of claim 8, wherein based on receiving an input to disable an edit command causes removal of a formatting element associated with the edit command.

15. A computer-implemented method, the method comprising:
accessing a reference-chart;
analyzing the reference-chart using a multi-modal visual model, wherein analyzing the reference-chart identifies one or more formatting elements;
based on the one or more formatting element, generating one or more edit commands;
based on the one or more edit commands, generating a reference-based chart using the reference-chart and an original chart, wherein the reference-based chart is formatted as an editable chart based on the one or more formatting elements of the reference-chart; and
causing display of the reference-based chart.

16. The method of claim 15, wherein the one or more elements are formatting elements of the reference-chart that enable replicating a visual style associated with an image of the reference-chart.

17. The method of claim 15, wherein generating an edit command is based on mapping a formatting element to an edit command of a spreadsheet application of the reference-based chart, the edit command is configured to control the formatting element.

18. The method of claim 17, wherein generating the reference-based chart is based on executing the one or more edit commands identified based on the reference-chart.

19. The method of claim 17, wherein causing display of the reference-based chart causes display of the one or more edit commands associated with generating the reference-based chart from the reference-chart, wherein the one or more edit commands are associated with interface controls to selectively enable or disable a corresponding edit command.

20. The method of claim 17, the method further comprising:
based on the one or more edit commands, generating a reusable chart template; and
storing the reusable chart template.
